(19) United States
(12) Patent Application Publication
(10) Pub. No.: US 2006/0068112 A1
(43) Pub. Date: Mar. 30, 2006

(54) Recycling process for boron nitride

(76) Inventors: Lloyd R. Chapman, Kingston, TN (US); Cressie E. Holcombe, Knoxville, TN (US)

Correspondence Address: Joseph T. Guy, Ph.D.;Nexsen Pruet Adams Kleemeir, LLC, PO Drawer 10648, Greenville, SC, 29603-0648, US

(21) Appl. No.: 10/953,086

(22) Filed: Sep. 29, 2004

(51) Int. Cl. B05D 1/40

(52) U.S. Cl. 427/345

(57) ABSTRACT

A process for recycling boron nitride paint or powder is provided. Boron nitride paint or powder is removed in an acid wash to form a wash solution. A caustic is added to the wash solution to form a neutralized wash solution. The neutralized wash solution is filtered to collect a boron nitride cake. The boron nitride cake is then washed and formed into boron nitride paint or powder.

### TECHNICAL FIELD

This invention relates to a recycling process for boron nitride paint or powder. More particularly, this invention relates to recovering boron nitride after it is used in processing operations to form a wash solution and then recovering the boron nitride from the wash solution to form usable boron nitride of varying purities.

### BACKGROUND ART

This invention relates to a recycling process for producing usable boron nitride from boron nitride paint previously used in forming materials such as metals or ceramics. Boron nitride paint is used as a temporary sacrificial coating in metal and ceramic forming, acting as a unique lubricating material, as a release agent, as well as to prevent or reduce impurities from developing on the surface of the metal or ceramic from reactions with the dies or environment. After the metal or ceramic is formed, the boron nitride paint is removed and disposed of at a high disposal cost.

Boron nitride paints can be used for coating glass fiber or glass fiber strands, commonly referred to as “fiberglas”, and can be used in materials formulations based on these glass fibers in order to provide lubrication and to improve properties of the materials. In some cases, removal of the coating after fabricating end products might be desirable.

Boron nitride is also used for coating mold-rings used for windshield glass forming operations as well as for other glass-“slumping” and glass-forming operations. Coatings used in these areas are temporary and can be removed after forming.

Boron nitride has been used for many years in isothermal forging of super-alloys and titanium, as well as for a “stop-off” coating for diffusion bonding of metals. After forming or processing, the boron nitride coatings must be removed, leading to waste material.

During hot-pressing of ceramic and metal materials, boron nitride coatings are used to prevent interactions with the graphite dies and housings as well as to reduce the effects of atmosphere on the materials. This boron nitride material is also used for a “one-time” processing and becomes waste after the forming operation.

When forming a metal, using a technique such as extrusion, boron nitride powder and coatings are used to reduce friction and sticking during the operation and lead to the formation of “cosmetic” finishes of the end product. Use of boron nitride in this area has been described in Light Metal Age, April 2003, v. 61 [Nos. 3-4], p. 86, “New Equipment Spotlight.” This operation also leads to waste boron nitride that could be reclaimed.

With molten metal operations, primary and secondary aluminum and other nonferrous as well as ferrous metals, boron nitride is used for coating many metal-transfer components and molten-metal-handling materials such as troughs, runners, stalk tubes, dross presses, ladles, etc. The use of coatings in these areas was discussed in U.S. Pat. No. 6,576,330, granted on Jun. 10, 2003 to Schenck et al. If the coated components are in a plant maintenance (PM) program, they can be cleaned off and recoated each shift, leading to waste boron nitride that could be reclaimed.

Boron nitride is also used as a filler material for plastics, ceramics, and in composite materials—often in relatively large volume fractions in order to increase the thermal conductivity of the materials or to act as a crack-blunting-phase and/or to otherwise improve the properties of the materials. Each of these areas of use can lead to “nonconforming product” classifications as well as scrap materials which can lead to waste boron nitride that could be reclaimed. Also, products that have been used, break or become outdated/outmoded often have to be disposed of at significant cost. The boron nitride contained within them which has heretofore been considered as waste boron nitride could be reclaimed.

The use of boron nitride to coat metal and ceramic preforms is well-known in the art. Ceramic, as used herein, refers to conventional refractory materials including oxide and non-oxide ceramics, glasses, fiberglas, and graphite. Those skilled in the art will recognize that boron nitride is used to coat other types of materials, even plastic and wood, for increasing lubricity or release properties. These coatings should not be considered as departing from the spirit and scope of the present invention.

When forming a metal or ceramic, often the surface of the metal or ceramic reacts with the dies or atmosphere of oxygen or carbonaceous gases to form undesirable phases on the surfaces. To remove the undesirable phases, the surface of the metal or ceramic is subjected to grinding or ablation, at a substantial cost penalty. Furthermore, grinding and ablation alter the article thereby reducing the consistency in dimension of the article. To avoid the problems associated with grinding or ablation, the art has advanced to coating the material with boron nitride. The boron nitride acts as a release agent on the surface of the material and eliminates undesirable phases/impurities from forming on the surface of the material.

Glass fiber coating has been described in U.S. Pat. No. 6,419,981 granted on Jul. 16, 2002, to Novich et al.; U.S. Pat. No. 6,593,255, granted on Jul. 15, 2003 to Lawton et al.

This process can use boron nitride paint in production of the fiber glass as well as for composites and products made with the glass fibers. While these patents indicate that the use of boron nitride can eliminate the need for a 380° C. “heat-cleaning” that previously was used for removing additives, the inherent high cost of boron nitride can totally prevent its utilization for industrial processes such as this, regardless of the improved processing and products that result. The removal and recovery of boron nitride from the glass fibers after their use in the glass fiber processing was apparently not considered. Such removal and recovery from the end products can lead to large amounts of boron nitride which could be recovered. This removal and recovery can reduce the cost of using boron nitride to a minimal level which can thus “enable” a costly process such as this to be fully utilized; whereas leaving the boron nitride in the end products, although giving rise to some good properties, can greatly increase the costs of the end products—possibly to the point where they could no longer be considered feasible. The present invention provides the enabling technology for this and similar situations.

It is also well known to use boron nitride paint to coat the surface of metal or ceramic preforms such as is disclosed in U.S. Pat. No. 4,096,076, granted Jun. 20, 1978 to Spiegelberg; U.S. Pat. No. 4,281,528, granted Aug. 4, 1981 to Spiegelberg et al.; U.S. Pat. No. 4,269,053, granted May 26, 1981 to Agrawal et al.; U.S. Pat. No. 4,518,736, granted May 21, 1985 to Jahn. Conventionally, boron nitride paint is produced by first processing a boron nitride powder using techniques as disclosed in U.S. Pat. No. 4,749,556, granted Jun. 7, 1988 to Parrish et al.; U.S. Pat. No. 4,784,978, granted Nov. 15, 1988 to Ogasawara et al.; U.S. Pat. No. 6,541,111 granted Apr. 1, 2003 to Fauzi et al.; U.S. Pat. No. 4,562,050 granted on Dec. 21, 1985 to Koeda et al.; and U.S. Pat. No. 5,854,155 granted on Dec. 29, 1998, to Kawasaki et al. After processing the boron nitride powder, it is well known that the boron nitride powder is typically combined with organic and/or inorganic suspension-binder agents along with volatilizable liquid such as nonaqueous solvents or water to form boron nitride paint or coating. Boron nitride paint is typically brush-painted, dipped, or sprayed onto a metal or ceramic preform and allowed to dry to form a coating. Air-spraying includes the use of a pressurized spray-gun, which is preferred, a suction-fed spray-gun or an aerosol spray such as described in U.S. Pat. No. 5,007,962 granted on Apr. 16, 1991, to Osborne. The coating reversibly adheres to the ceramic or metal surface. The metal or ceramic preforms are formed using a variety of processes such as hot-pressing, extrusion, “slumping”, isothermal forging or super-plastic forming, after which the boron nitride paint is removed.

“Super-plastic forming”, or SPF, has been further described in U.S. Pat. No. 5,974,847 granted Nov. 2, 1999, to Saunders et al. Additionally, “quick plastic forming”, or QPF, has been introduced to allow more-rapid production of formed metal parts in U.S. Pat. No. 6,253,588 granted Jul. 3, 2001, to Rashid et al., and is becoming important for special shapes of automobile parts. These processes are more thoroughly discussed in “Advantage: Aluminum,” Ward's AutoWorld; Mar. 1, 2004; “‘Quick Forming’Hits Fast Track,” Aluminum Now; vol. 6, no. 2 [March/April 2004] and “Cadillac Meets Challenge Head-On,” Aluminum Now; vol. 6, no. 4 [July/August 2004]; p. 12. The use of boron nitride for these processes has also been described in U.S. Pat. No. 5,819,572 granted Oct. 13, 1998 to Krajewski; U.S. Pat. No. 6,047,583 granted Apr. 11, 2000 to Schroth; and U.S. Pat. No. 6,305,202, granted Oct. 23, 2001, to Kleber. The latter indicated the utility of boron nitride, for the SPF process, in coating flattened sheets of aluminum “to function as a release agent to prevent the formed part or panel 21 from adhering to the forming die and to enhance the stretching and formation of the part during forming operation.” The SPF and/or QPF processes would inherently give rise to large amounts of boron nitride material as waste.

Boron nitride paint is frequently removed from the formed metal or ceramic substrates by washing it with an acidic wash. The boron nitride and acidic wash combine to form a wash solution that is considered waste. The waste is often considered “hazardous” due to the high acid content, or very low pH, and the ingredients that are added in order to remove the boron nitride from the substrates.

Other methods for removing boron nitride paint from surfaces include: washing with an alkaline wash; power washing with water or nonaqueous solvents; soaking in water or nonaqueous solvents; using any commercial cleaning agents, leaching, oxidizing, grit-blasting or carbon dioxide (dry ice) blasting, or electrochemical dissolution or etching or other cleaning steps that can take the boron nitride off of the surface or substrate or remove it from composites or bulk materials which contain boron nitride. Products resulting from such processes have been considered waste products and are costly to dispose of.

It is recognized that boron nitride powder alone can be used for processing operations, such as described for isothermal forging in U.S. Pat. No. 4,228,670 granted Oct. 21, 1980, to Corti et al.; and in U.S. Pat. No. 4,984,348 granted Jan. 15, 1991, to Cadwell. Also, the use of boron nitride powder for electrostatic powder spray systems used in metal extrusion was described in Light Metal Age, April 2003, v. 61 [Nos. 3-4], p. 86, “New Equipment Spotlight.” In cases such as these, or other manufacturing operations utilizing boron nitride powder, boron nitride powder can remain on surfaces after the processing operations. The boron nitride powder can be removed from these surfaces with the methods discussed for boron nitride paint, forming a wash solution of the boron nitride, which heretofore would be considered as a waste solution. The recycling process for boron nitride paint as used herein should not be considered as limiting to surfaces that were initially coated with a “paint” or “coating” that can only be a liquid dispersion of boron nitride.

In many areas, the manufacturing cost in processing metals and ceramics remains costly due, in part, to the high disposal costs of wash solutions or materials that are considered “waste product” along with the cost of purchasing new boron nitride powder or paint. There has been a long felt desire for a process for recycling boron nitride paint which is economical, reliable, and which can be used as a source of “new” boron nitride for powder uses or for paint uses. The final powder and/or paint can be adjusted in overall purity to allow multiple end uses of the recovered boron nitride.

The present invention provides a process wherein used boron nitride paint or powder can be recycled into production quality boron nitride paint or recycled into boron nitride powder.

### SUMMARY

It is an object of the present invention to provide an improved process for forming metals and ceramics.

It is another object of the present invention to lower the cost of manufacturing metals and ceramics.

These and other advantages are provided in a process for recycling boron nitride paint or boron nitride that is contained in end products or scrap. The following should not be considered as limiting in scope.

A particular advantage is that the boron nitride recycling process eliminates high disposal costs and transforms virtually useless material into a high value end products. The purity level of the end products can be tailored as needed for different uses.

An example of a particularly-preferred embodiment is provided in a process for recycling boron nitride paint. The process comprises removing boron nitride paint with an acid wash to form a wash solution. A caustic is added to the wash solution to form a neutralized wash solution. The neutralized wash solution is filtered to collect a boron nitride cake. The boron nitride cake is then washed to remove soluble residual material and then is formed into boron nitride paint.

Another embodiment is provided in a process for recycling boron nitride paint. The process comprises removing boron nitride paint from a substrate with an acid wash to form a wash solution and then adding a caustic to the wash solution to form a neutralized wash solution. The neutralized wash solution is filtered to collect a boron nitride cake, and the boron nitride cake is washed to remove soluble residual material. After the boron nitride cake is washed, it is dried and milled into boron nitride powder, typically using a fluid-energy or “jet” mill.

Yet another embodiment is provided in a process for recycling boron nitride paint. The process comprises removing the boron nitride paint from a surface by washing the surface with an acidic solution to form a boron nitride suspension. A caustic is then added to the boron nitride suspension for neutralization. The neutralized wash solution is filtered to form a boron nitride cake. The boron nitride cake is washed further to remove soluble residual material.

Yet still another embodiment is provided in a process for forming a material. The process for forming a material comprises applying boron nitride paint to the material. The boron nitride paint is later removed from the material using an acid wash to form a wash solution. A caustic is added to the wash solution to form a neutralized wash solution. The neutralized wash solution is filtered to collect a boron nitride cake. The boron nitride cake is then washed further to remove residual soluble material.

Yet still another embodiment is provided in a process for reclaiming boron nitride. The process comprises applying boron nitride paint or utilizing boron nitride powder in a process, then removing the boron nitride to form a wash solution followed by neutralization or water washing and then filtering and further washing to produce a boron nitride cake that is then dried and milled to form boron nitride powder “streams” of varying purity, then blending the “streams,” and producing boron nitride paint if desired. The blending can be done either as powder or paint and can be recycled by blending with unused or “virgin” boron nitride powder or paint.

A particularly preferred embodiment is provided in a process for using boron nitride. The process comprises:
(a) utilizing a boron nitride containing material in a process to form a boron nitride containing product;
(b) removing boron nitride byproduct from said boron nitride containing product;
(c) filtering said boron nitride byproduct to form a boron nitride cake;
(d) washing said boron nitride cake to form a once purified boron nitride cake;
(e) drying said once purified boron nitride cake to form a dried boron nitride cake;
(f) milling said dried boron nitride cake to from a powdered boron nitride; and
(g) reforming said boron nitride containing material from said powdered boron nitride.

### BRIEF DESCRIPTION OF THE DRAWINGS

FIG. 1 illustrates a flow chart of the process for recycling boron nitride paint into usable boron nitride, whereby the boron-nitride-paint-coating is removed with an acidic wash.

FIG. 2 illustrates a flow chart of the process for recycling boron nitride paint into usable boron nitride paint, whereby the boron-nitride-paint-coating is removed with an acidic wash.

FIG. 3 illustrates a flow chart of the process for recycling boron nitride paint into usable boron nitride powder, whereby the boron-nitride-paint-coating is removed with an acidic wash.

FIG. 4 illustrates a flow chart of the most generic process for recycling boron nitride paint, whereby the boron-nitride-paint-coating is removed by various means.

### DESCRIPTION OF THE PREFERRED EMBODIMENTS

The present invention will be described with reference to the figures which are an integral part of the present disclosure. In the various figures similar elements are numbered accordingly.

A recycling process for boron nitride paint is provided and includes neutralizing and filtering acidic boron nitride wash solution. Boron nitride paint is often applied to a material preform, such as metal or ceramic substrates/panels, to aid the forming process, to improve release properties, or to prevent undesirable phases/impurities from forming on the surface of the material. Ceramic, as used herein, refers to conventional refractory materials including oxide and non-oxide ceramics, glasses, fiber glass or fiberglas, and graphite. After forming, the boron nitride paint is frequently removed using an acid wash. Conventionally, this mixture of boron nitride paint and acid wash is disposed of at a high cost to the manufacturer. Additionally, subsequent operations require additional boron nitride which further increases the operating cost.

Boron nitride is a high-temperature material that is usable in almost all types of atmospheres. It has exceptionally high thermal conductivity and is commonly used as a release agent and as a container material for molten materials such as aluminum, magnesium, silicon, iron, steels, copper, cryolite, tin, etc. Boron nitride is also used as a barrier material or container for metal oxides and graphite. Boron nitride is also an ideal high-temperature lubricant for hot-pressing, isothermal forging, super-plastic forming, and quick plastic forming of materials including nonferrous metals and superalloys.

Boron nitride paints, when applied to metals, ceramics, glasses, fiber glass or fiberglas, and graphite, act as a releasing agent and lubricant and can be used for multiple forming methods. Boron nitride paints are typically a combination of boron nitride powder, organic and/or inorganic suspension agents/binders, along with a volatilizable liquid such as water or nonaqueous solvents; however, other compositions comprising boron nitride can be used without departing from the scope of the present invention.

U.S. Pat. No. 5,168,193, granted Dec. 1, 1992 to Hoegler, and U.S. Pat. No. 4,733,055, granted Mar. 22, 1988 to Cunningham, provide further representative and preferred boron nitride materials and uses including ZYP Coatings' Boron Nitride Lubricoat which is a particularly preferred material for use in the present invention.

The boron nitride powder typically used in paint product has a subsieve particle size, below −325 Mesh. Boron nitride individual particles are generally less than 1 micrometer in size but do not exist individually; rather, they exist in popcorn-like or pancake-stack-like agglomerates due to the platelike nature of the boron nitride compound. The agglomerates often have sizes in the range of 1 to 15 micrometers, where an average size of 5 to 8 micrometers is typical. In the paint products, the boron nitride is generally present in about one-twentieth up to one-third of the weight of the entire paint formulation on a wet basis—i.e., 5 to 33 wt. %. The more dispersed the agglomerated particles are and the finer their overall size, the less weight of boron nitride that is generally required to coat a surface area and yield the necessary performance.

A broad range of organic suspension agent/binder materials is contemplated including cellulosics, acrylics, vinyls, methacrylics, latexes and the like. Typically, an organic suspension agent/binder is dispersed in water, alcohols, glycols, esters and the like. A broad range of inorganic suspension agent/binder materials is contemplated including specialized materials like bentonite, montmorillonite, smectite, and hectorite; colloidal aluminum oxide, colloidal silica, acid-peptized aluminum oxide-monohydrate, soluble alkali silicates, aluminum and magnesium phosphates, and the like. As mentioned previously, an organic material, an inorganic material, or both of them can be used in a boron nitride coating in order to achieve the necessary suspendability and binding to the substrate that allows the best performance of the boron nitride for its intended use. The volatilizable liquid is one that preferably air dries within a reasonable time and which does not react or combine with the other components. Water is generally preferred, since it is easy to handle; even though drying make take longer, this can be adjusted by increasing the temperature of the substrate. Alcohols, acetone, methylethylketone (also referred to as MEK), and other nonaqueous systems are also contemplated but are often less preferred in high-temperature operations due to their flammability and “hazardous” handling requirements.

Boron nitride paint is typically painted, dipped, or sprayed onto a material, such as a metal or ceramic, and allowed to dry to form a coating. The coating adheres to the surface of the material. When the material undergoes processes such as super-plastic forming, quick plastic forming, isothermal forging, extrusion, hot-pressing, de-canning of hot-isostatic-pressed (also referred to as HIPed) components, glass-forming and melting, metal melting, or composite forming, the coating acts as a release agent and/or a lubricant. Without the boron nitride paint, some processing operations cannot occur, since there is not enough lubrication or release-ability during the processing.

Grinding and ablation are processes that largely increase the cost of manufacturing materials and potentially alter the dimensions and/or surface structure of formed parts. Boron nitride acts as a release agent on the substrate surfaces and eliminates undesirable phases/impurities from forming.

For many materials, such as aluminum panels for SPF or QPF, glass, fiber glass or fiberglass superalloys, and others, boron nitride paint is required for imparting necessary release, formability, or other properties during processing. While costs such as grinding and ablation may be avoided in some cases by using boron nitride paints, the costs associated with using boron nitride paint are severe, due to the inherent high cost of the very-high-temperature production processes for manufacturing boron nitride powder, using processes such as described in U.S. Pat. No. 4,749,556, granted Jun. 7, 1988 to Parrish et al.; U.S. Pat. No. 4,784,978, granted Nov. 15, 1988 to Ogasawara et al.; U.S. Pat. No. 6,541,111 granted Apr. 1, 2003 to Fauzi et al.; U.S. Pat. No. 4,562,050 granted on Dec. 21, 1985 to Koeda et al.; and U.S. Pat. No. 5,854,155 granted on Dec. 29, 1998, to Kawasaki et al. The costs of using boron nitride paint include purchasing, or producing, the boron nitride paint and disposing of the boron nitride containing wash removed from the material, where the wash is often considered “hazardous” due to the pH and the constituents having to be reactive enough, i.e. harsh enough, to get the boron nitride off of the substrate surface. Boron nitride is not easily removed and cannot be dissolved off due to its chemical inertness/stability. To remove boron nitride paint from a material such as a metal or ceramic, a harsh/aggressive acid wash is thus normally used. Typically, the acid wash contains water and a mixture of acids such as sulfuric and hydrofluorosilicic acids. Other acids which may be included in acid washes including mineral acids such as nitric, hydrochloric, hydrofluoric, and phosphoric as well as organic acids such as acetic and formic acids. The acid, or acid components, in the acid wash facilitates the complete removal of boron nitride from the material by affecting the residual suspension agent/binder phases or by slightly dissolving the substrate enough to get the boron nitride layer to release. The acid wash preferably should be aqueous containing enough acid to adequately remove the boron nitride paint. In some cases, the pH can be in the range of less than 1, such as 0.25 up to 5. Often, a pH at or below 2 may be used. An exemplary acid wash is an aqueous solution comprising a mixture of sulfuric acid along with hydrofluorosilicic acid (also referred to in the art as fluosilicic acid and fluorosilicic acid). A mixture of hydrochloric acid along with fluosilicic acid has been shown to be effective in leaching aluminum ores to remove the aluminum oxide in U.S. Pat. No. 3,816,605 granted on Jun. 11, 1974 to Belsky; thus, this mixture can also be considered for leaching boron nitride paint that contains aluminum oxide resulting from a suspension agent/binder phase, such as when peptized aluminum oxide monohydrate or colloidal alumina is used in the suspension agent/binder phase for a boron nitride paint. The above description of acid washes should not be considered as limiting in scope. Prior to the present invention, the wash water would have to be created, received for disposal, and separately disposed of at a high cost.

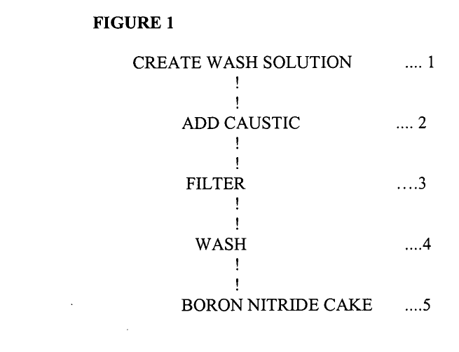

A flow chart for the process of recycling used boron nitride paint into usable boron nitride is provided as FIG. 1. The preferable coating is a paint of boron nitride powder dispersed in a liquid of peptized aluminum oxide monohydrate as described in U.S. Pat. No. 6,576,330, granted on Jun. 10, 2003 to Schenck et al. A paint such as Boron Nitride Lubricoat from ZYP Coatings, Inc., described in U.S. Pat. No. 5,168,193, granted Dec. 1, 1992 to Hoegler, or similar coatings diluted with water to achieve desired thicknesses and adherence would be typical. The relatively low pH of the coating allows good stability of the boron nitride suspension along with excellent adherence to many substrates derived from its chemical bond-down, i.e., reaction to some extent with the substrate. However, other coatings consisting of boron nitride with organic or inorganic suspension agents/binders and a volatilizable liquid such as water or nonaqueous solvents are possible as previously mentioned. These other coatings and compositions should not be considered as departing from the spirit and scope of the present invention.

Boron nitride paint is removed from a substrate using an acid wash, as described above, that contains at least one acid to facilitate the complete removal of the boron nitride paint from the substrate. This acid wash gets the boron nitride into suspension and is preferably a mixture of sulfuric and hydrofluorosilicic acids. The mixture of the acid wash, boron nitride particles/agglomerates, residual suspension agent/binder materials, and other materials such as dissolved substrate material form a wash solution, 1. With the boron nitride in suspension with the acid wash, the wash solution is conventionally not reused and is considered waste. This liquid can be passed through a filter press to concentrate the solids into a clay-like mass. The present invention, however, receives the wash solution or the clay-like mass and neutralizes it by adding sodium hydroxide or a similar caustic, 2, with or without further water addition. Caustics commonly used to neutralize the wash solution include sodium, potassium, ammonium, and lithium hydroxides or carbonates; calcium and/or other alkaline earth hydroxides or carbonates; and mixtures of these. The most preferred caustic is sodium hydroxide. The caustic raises the pH in the wash solution or clay-like mass; and the boron nitride settles out of the suspension while dissolved material in solution or colloidal suspension remains. To take the boron nitride out of suspension, enough caustic should be added to raise the pH to a range of 6 to 8, closer to a pH of 7 being the preferred pH. The neutralized wash solution is filtered further, 3, and washed, 4, preferably in a filter press equipped for washing. The neutralized filter cake is washed, 4, using water or low-pH acidic water. Low-pH acidic water generally provides purer boron nitride but creates more waste due to small amounts of boric acid in solution. The low-pH acidic water contains similar acids as the acid wash mentioned above and generally has a pH of 2 or less. The boron nitride particles remain in the filter as a filter cake of boron nitride, 5, ready for use in forming boron nitride paint or powder—with or without additional washing with purified water.

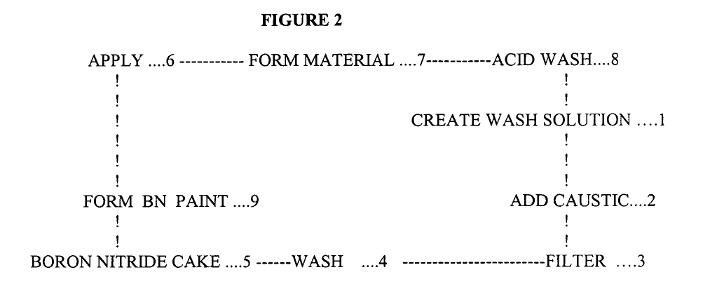

FIG. 2 is a flow chart for the process of recycling used boron nitride paint into usable boron nitride paint. Boron nitride paint is applied to a material, 6, such as a preform aluminum panel to form a coated material. The boron nitride paint is applied using any of the application methods discussed above. The coated material is then formed, 7, using any technique as known in the art. After forming, the boron nitride paint is washed off of the material, 8, using water that contains at least one acid to facilitate the complete removal of the boron nitride paint from the formed material. The mixture of the acid wash and boron nitride form a wash solution, 1, as also illustrated in FIG. 1. The wash solution may optionally be passed through a filter press to concentrate the solids into a clay-like mass. The wash solution is neutralized by adding a caustic, 2, such as sodium hydroxide, to form a neutralized wash solution. If the clay-like mass is to be neutralized, it is suspended in water before neutralization. The neutralized wash solution is filtered, 3, and washed, 4, preferably in a filter press equipped for washing. The boron nitride collects in the filter as a filter cake of boron nitride, 5. Additional organic or inorganic suspension-agent/binder materials such as those previously mentioned may be added to the boron nitride to form boron nitride paint. These additional materials are typically mixed under rapid shear to uniformly wet and suspend the boron nitride. The boron nitride paint can be used for any known purpose including applying it to the surface of a material, forming the material, and then recycling the boron nitride paint to again form usable boron nitride. The recycled boron nitride is often better in overall purity compared to the original boron nitride when the boron nitride coating is the preferred one mentioned above that utilizes the peptized aluminum oxide monohydrate for the suspension agent/binder phase, since the acid washing removes the colloidal-particle residue from this binder along with boron oxide or boric acid and impurities. The recycled boron nitride may not be better in purity compared to the original boron nitride if the use-temperature is high enough to cause the original colloidal material to crystallize or sinter significantly such that it will not be entrained in the wash but will remain with the boron nitride in the filter cake. For processes such as SPF or QPF with aluminum, the processing temperatures are typically below 565° C. or below 1050° F., as described in U.S. Pat. No. 6,085,571 granted Jul. 11, 2000, to Brinas et al., thus these processes with the preferred coating will yield high-purity recycled boron nitride.

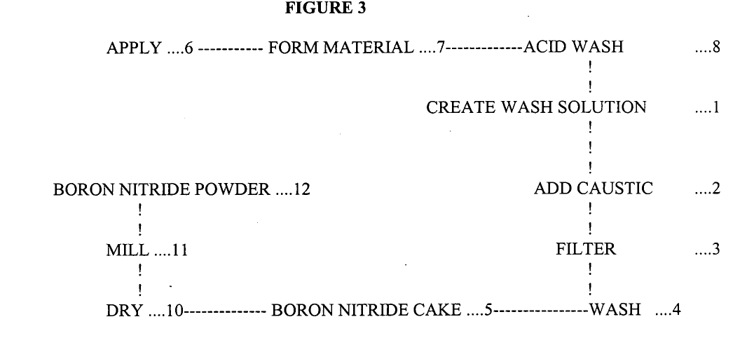

A flow chart for the process of recycling used boron nitride paint into usable boron nitride powder is provided as FIG. 3. The initial steps for recycling used boron nitride paint into usable boron nitride powder are the same as described above and illustrated in FIG. 2. Boron nitride paint is applied to a material, 6, to form a coated material. The coated material is then formed, 7, and the boron nitride paint is washed off of the material, 8, using an acid wash. As also illustrated in FIG. 1 and FIG. 2, the mixture of the acid wash and boron nitride form a wash solution. The neutralized wash solution is then filtered, 3, and washed, 4, to collect a filter cake of boron nitride, 5. To form boron nitride powder, the filter cake is dried, 10, to evaporate the water and other impurities and then milled, 11, into usable boron nitride powder, 12. The filter cake of boron nitride is typically dried at a temperature range of 30 to 150° C. until thoroughly dried, and the dried boron nitride cake is then milled, typically with a fluid-energy, or “jet” mill, to create particles/agglomerates that are typically around 5 to 8 micrometers in average size. The individual boron nitride particles are less than 1 micrometer as is typical for boron nitride but are still in an agglomerated state as previously described. The usable boron nitride powder has a very-low water-soluble boron content; and therefore, the boron nitride powder has a very high purity, typically in the range of >99% pure boron nitride. The boron nitride powder can be used for any known purpose including applying it to the surface of a material for forming or producing it into boron nitride paint. The higher-purity boron nitride resulting from recycling, containing substantially less boric acid that the initial material, is essentially ultra-high purity, “cosmetic grade” boron nitride. Having less boric acid can result in less tackiness and improved lubricity and release properties of boron nitride at its use-temperature, since boric acid forms boron oxide which becomes glassy/tacky at modest temperatures, even at or below 450° C.

Considering boron nitride paint, the coating is applied to a material preform, such as metal or ceramic substrates/panels, to aid the forming process, to improve release properties, or to prevent undesirable phases/impurities from forming on the surface of the material. After the metal or ceramic is formed, the boron nitride paint is washed off typically using an acid wash. The boron nitride paint and acid wash are received, neutralized using a caustic, passed through a filter press, and washed. The filter cake is either used directly for boron nitride paint production or dried and milled into usable boron nitride powder. The acid wash, neutralization, and further washing reduces the inherent boric acid or boron oxide content of the boron nitride. Depending on the suspension agent/binder initially used for the boron nitride paint, the acid wash, neutralization, and further washing can yield ultrahigh purity, essentially “cosmetic-grade,” boron nitride. This increase in overall purity of the boron nitride results when the processes of washing, neutralization, and filtering reduces the content of organic suspension agent/binders or their residues along with reducing or eliminating the inorganic suspension agent/binder residues.

The suspension agent/binder materials often contain organic materials that provide room-temperature paintability and adherence to the substrate. The suspension agent/binder materials also often contain inorganic phases that provide the higher-temperature adherence to the substrate and performance for the end use. These inorganic phases typically can be solutions such as those containing silicates or phosphates or else can consist of submicron colloidal phases. After processing, these suspension agent/binder phases are generally considerably modified from their initial state in boron nitride paint. Organic phases can be altered with heating to yield carbon residues as well as other materials that remain along with the boron nitride. Inorganic phases can remain as soluble phases, such as silicates that are heated to relatively low temperatures of only a few hundred degrees Centigrade, or they can be fully converted to insoluble phases by the removal of hydroxides and water and by their reactions with other constituents of the paint and/or substrate. Inorganic phases can crystallize, sinter, or densify with particle growth as well—often with such changes occurring more generally when the temperature is around 1000° C. or higher but depending on the phases involved. Alternatively, some colloidal binders can remain amorphous/noncrystalline and colloidal after being heated—generally if the use-temperature is around 500 to 800° C. but also depending on the phases involved. The end condition of these suspension agent/binder phases is thus quite dependent on the use-temperature of the coating and its exposure time at the use-temperature. Often, the final condition of the initial constituents of the boron nitride paint is not known.

Since there are numerous possibilities of phases that can exist from boron nitride paint residues and since methods of removal of boron nitride take advantage of the inert nature of the compound, boron nitride [its being stable to acids, bases, solvents, oxidation, reduction, etc.], aggressive materials and methods can be utilized to remove the binders, binder residues, additives, and even bulk constituents in order to recover the boron nitride. The high-value of boron nitride can allow relatively-high-cost materials and processes to be used for removing and recovering boron nitride. Boron nitride paint is frequently removed from the formed metal or ceramic substrates by washing it with an acidic wash. The boron nitride and acidic wash combine to form a wash solution that is considered waste. The waste is often considered “hazardous” due to the high acid content, or very low pH, and the ingredients that are added in order to remove the boron nitride from the substrates.

If the suspension agent/binder residues can be washed out or dissolved out during recovery steps, then a very-high-purity, even “cosmetic grade” boron nitride can result. Suspension agent/binder phases are typically added in low percentages in order to have a final boron nitride content rather high and thus to exhibit more of the properties of the boron nitride and little or no properties of the residual suspension agent/binder phase. If these suspension agent/binder residues cannot be washed out or otherwise removed [by methods such as leaching/dissolution, oxidation, etc.], then a less pure boron nitride can result. Blended coatings, such as a blended paint described in U.S. Pat. No. 5,819,572 granted Oct. 13, 1998 to Krajewski, can have phases that cannot be removed or else can be removed with great difficulty and cost due to the high content of ingredients other than boron nitride. Also, coatings that contain glass-forming or vitreous constituents, such as described in U.S. Pat. No. 4,096,076, granted Jun. 20, 1978 to Spiegelberg; U.S. Pat. No. 4,281,528, granted Aug. 4, 1981 to Spiegelberg et al., can have residual phases that cannot be removed or else can be removed with great difficulty and cost due to the relative inertness and/or insolubility of the residual phases in solvent systems. The recovery process can eliminate phases that are soluble in aqueous or nonaqueous systems and/or which can be removed by oxidation or otherwise treating the “waste” boron nitride. Examples of phases that could be removed by oxidation are carbon and graphite as well as wood or plastic constituency—or organic residuals. However, it is recognized that some materials cannot be readily removed and/or would be very expensive and uneconomical to remove. In such cases, a much less pure boron nitride recovered product can result.

The above boron nitride streams are preferably categorized by a characteristic such as purity. By way of example, the boron nitride can be classified as category 1) being very-high-purity boron nitride, containing less boron oxide or boric acid than normal paint-grade boron nitride—being over 99% pure and even reaching the designation of “cosmetic-grade” boron nitride, which is considered about the highest purity boron nitride available; category 2) being moderate purity boron nitride, which contains undissolved phases of silicates, phosphates, oxides, carbon, etc.—with contaminants at around the 1 to 10% level and category 3) being a mixed-phase material containing other compounds. Each of these streams can be blending with virgin boron nitride, referred to as being “sweetened” in the art, or with the other streams to yield product which will perform adequately for the intended end use.

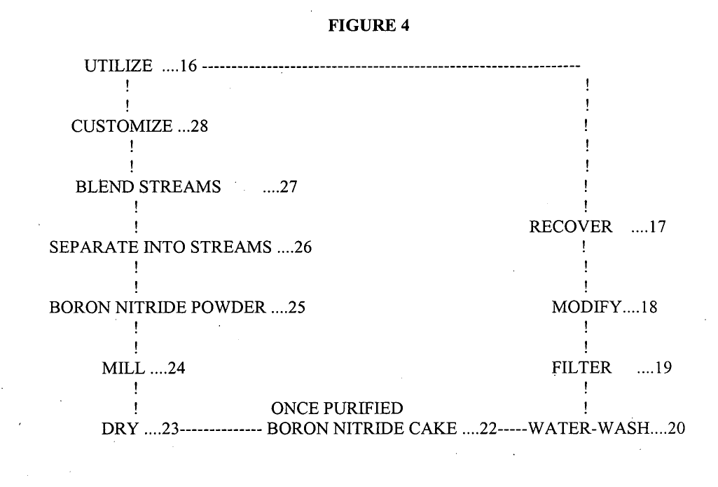

A flow chart for a preferred process for reclaiming boron nitride is provided as FIG. 4.

The process comprises utilizing boron nitride material such as boron nitride paint or boron nitride powder in a process, 16, wherein the boron nitride material is either sacrificial or some fraction of the boron nitride material is retrievable due to quality issues, breakage, test samples or any other method by which the boron nitride is not permanently incorporated into the product relative to the environment of concern. In other words, some fraction of the boron nitride is incorporated in a form from which it is advantageous to recover and recycle the boron nitride. Then the process, like those illustrated in FIGS. 1-3, involves removing the boron nitride to form a recovered boron nitride phase, 17. The recovered boron nitride phase will contain boron nitride, adjuvants consistent with the application and possibly materials incorporated from the removal process such as acid from an acidic wash process; alkaline from an alkaline wash; water or nonaqueous solvents from power washing; water or nonaqueous solvents from a soaking process or other materials consistent with removal processes such as commercial cleaning agents, leaching agents, oxidizing agents, residue from blasting operations, or electrochemical dissolution or etching agents or other cleaning steps that can take the boron nitride off of the surface or substrate or remove it from composites or bulk materials which contain boron nitride.

The recovered boron nitride phase is then optionally modified, 18, such as by neutralization or dilution. The recovered boron nitride phase which has been optionally modified is then filtered, 19, water-washed, 20, and formed into a once purified boron nitride cake, 22, preferably using a filter press steps 18, 19, 20 and 22 can be repeated multiple times to remove impurities. The once purified boron nitride cake is dried, 23, and then milled, 24, to create the boron nitride powder, 25, of typical agglomerate size. The purity of such boron nitride powder is dependent on many things as discussed previously. The recycled boron nitride powder is optionally separated into streams, 26, based on an attribute such as purity, particle size, color, crystallinity, concentration or an attribute relevant to the intended process. Each of these streams can be blended, 27, with virgin boron nitride, for example, or by addition of one of the other streams to form a customized boron nitride powder, 28, which will perform adequately for the intended end use. This blending can be done after the recycled boron nitride has been milled, 24, into the boron nitride powder. Alternately, the boron nitride powder streams can be prepared into boron nitride paint streams which then can be blended to yield product which will perform adequately for the intended end use. The process begins again in the apply/utilize, 16, step where the recycled boron nitride is re-used either as boron nitride powder or as boron nitride paint.

The process of recycling boron nitride paints converts a waste product with a high disposal cost into a high value product, either boron nitride powder or boron nitride paint, that can be continuously reused for paints or powders. This recycling process removes the expensive steps of frequently purchasing new boron nitride powder or paint and virtually eliminates the cost associated with disposing of boron nitride as waste product. This recycling process lowers the cost of using boron nitride powder or paints as a process facilitator and thereby lowers the cost of manufacturing materials utilizing boron nitride paints—basically “enabling” such processes to be utilized economically; whereas without this recycling process, the manufacturing processes that require boron nitride can be economically non-feasible.

For the purposes of the present invention the morphology of the boron nitride is not limiting. Hexagonal boron nitride is particularly preferred due to its widespread use. Use of this technology with other forms of boron nitride such as cubic boron nitride and other high-density, diamond-like BN phases such as the Wurtzite form are considered to be within the scope of the invention.

While preferred embodiments of the process for recycling boron nitride paint have been shown and described, it will be understood that it is not intended to limit the disclosure, but rather it is intended to cover all modifications and alternate methods failing within the scope of the invention as defined in the appended claim.

We claim:

1. A process for recycling boron nitride paint comprising the steps:
removing said boron nitride paint in an acid wash to form a wash solution containing suspended boron nitride;
adding a caustic to said wash solution to form a neutralized wash solution;
filtering said neutralized wash solution to collect a boron nitride cake;
washing said boron nitride cake; and
forming a reconstituted boron nitride paint from said boron nitride cake.

2. The process of claim 1, wherein said acid wash comprises at least one of sulfuric acid and hydrofluorosilicic acid.

3. The process of claim 1, wherein said acid wash has a pH of 0.25 to 5.

4. The process of claim 3 wherein said acid wash has a pH of 1 to 5.

5. The process of claim 1 wherein said acid wash has a pH of no more than 2.

6. The process of claim 1, wherein said caustic is sodium hydroxide.

7. The process of claim 1, wherein said neutralized wash solution has a pH range between 6 and 8.

8. The process of claim 1 further comprising coating a metal with said reconstituted boron nitride paint.

9. The process of claim 1 further comprising coating a ceramic with said reconstituted boron nitride paint.

10. The process of claim 1, wherein suspension agent/binder materials are added to said boron nitride cake to form said reconstituted boron nitride paint.

11. The process of claim 1 further comprising separating said boron nitride cake into aliquots based on a measured attribute.

12. The process of claim 11 wherein said attribute is purity.

13. The process of claim 11 further comprising mixing an aliquot with a secondary boron nitride powder.

14. The process of claim 13 wherein said secondary boron nitride powder is a second aliquot.

15. A process for recycling boron nitride paint into boron nitride powder comprising the steps of:
removing said boron nitride paint in an acid wash to form a wash solution;
adding a caustic to said wash solution to form a neutralized wash solution;
filtering said neutralized wash solution to collect a boron nitride cake;
washing said boron nitride cake;
drying said boron nitride cake; and
milling said boron nitride cake into said boron nitride powder.

16. The process of claim 15, wherein said acid wash comprises at least one of sulfuric acid and hydrofluorosilicic acid.

17. The process of claim 15, wherein said acid wash has a pH of 0.25 to 5.

18. The process of claim 17, wherein said acid wash has a pH of 1 to 5.

19. The process of claim 15, wherein said acid wash has a pH of less than 2.

20. The process of claim 15, wherein said caustic is sodium hydroxide.

21. The process of claim 15, wherein said neutralized wash solution has a pH range between 6 and 8.

22. The process of claim 15 further comprising separating said boron nitride cake into aliquots based on a measured attribute.

23. The process of claim 22 wherein said attribute is purity.

24. The process of claim 15 further comprising mixing an aliquot with a secondary boron nitride powder.

25. The process of claim 24 wherein said secondary boron nitride powder is a second aliquot.

26. A process for recycling boron nitride paint comprising the steps of:
removing said boron nitride paint from a surface by washing said surface with an acidic solution to form a boron nitride suspension;
adding a caustic to said boron nitride suspension to yield a neutralized material;
filtering said neutralized material to form a boron nitride cake; and
washing said boron nitride cake to form reconstituted boron nitride.

27. The process of claim 26 further comprising combining said reconstituted boron nitride with suspension agent/binder materials to form a reconstituted boron nitride paint.

28. The process of claim 27 further comprising applying said reconstituted boron nitride paint to a surface of a material.

29. The process of claim 28 further comprising forming said material.

30. The process of claim 29 further comprising removing said reconstituted boron nitride paint from said surface of said material by washing said surface with an acidic solution to form a reconstituted boron nitride solution.

31. The process of claim 26, wherein said boron nitride is dried and then milled to form a boron nitride powder.

32. The process of claim 26 further comprising separating said boron nitride cake into aliquots based on a measured attribute.

33. The process of claim 32 wherein said attribute is purity.

34. The process of claim 32 further comprising mixing an aliquot with a secondary boron nitride powder.

35. The process of claim 34 wherein said secondary boron nitride powder is a second aliquot.

37. The process of claim 26, wherein said acid wash comprises at least one of sulfuric acid and hydrofluorosilicic acid.

38. The process of claim 26, wherein said acid wash has a pH of 0.25 to 5.

39. The process of claim 26 wherein said acid wash has a pH of 1 to 5.

40. The process of claim 26 wherein said acid wash has a pH of no more than 2.

41. The process of claim 26, wherein said caustic is sodium hydroxide.

42. The process of claim 26, wherein said neutralized wash solution has a pH range between 6 and 8.

43. A process for forming a material comprising the steps of:
applying a boron nitride paint to said material;
washing said boron nitride paint off of said material using an acid wash to form a wash solution;
adding a caustic to said wash solution to form a neutralized wash solution;
filtering said neutralized wash solution to collect a boron nitride cake; and
washing said boron nitride cake to form boron nitride.

44. The process of claim 43, wherein said material is a metal.

45. The process of claim 44, wherein said forming method of said metal is selected from super-plastic forming and quick plastic forming.

46. The process of claim 43, wherein said material is a ceramic.

47. The process of claim 46, wherein said forming method of said ceramic is hot pressing.

48. The process of claim 43, wherein said material is formed after the step of applying said boron nitride paint to said material and before the step of washing said boron nitride paint off of said material.

49. The process of claim 43, wherein said acid wash comprises at least one of sulfuric acid and hydrofluorosilicic acid.

50. The process of claim 43, wherein said acid wash has a pH of 0.25 to 5.

51. The process of claim 50, wherein said acid was has a pH of 1 to 5.

52. The process of claim 43 wherein said acid wash has a pH of no more than 2.

53. The process of claim 43, wherein said caustic is sodium hydroxide.

54. The process of claim 43, wherein said neutralized wash solution has a pH range between 6 and 8.

55. The process of claim 43 further comprising combining said boron nitride with suspension agent/binder materials to form a reconstituted boron nitride paint.

56. The process of claim 43, wherein said boron nitride is dried and then milled to form a boron nitride powder.

57. A process comprising:
utilizing a boron nitride containing material in a process to form a boron nitride containing product;
removing boron nitride byproduct from said boron nitride containing product;
filtering said boron nitride byproduct to form a boron nitride cake;
washing said boron nitride cake to form a once purified boron nitride cake;
drying said once purified boron nitride cake to form a dried boron nitride cake;
milling said dried boron nitride cake to from a powdered boron nitride; and
reforming said boron nitride containing material from said powdered boron nitride.

58. The process of claim 57 further comprising separating said powdered boron nitride into at least a first stream and a second stream.

59. The process of claim 58 wherein said first stream is further combined with a second boron nitride.

60. The process of claim 59 wherein said second boron nitride is said second stream.

61. The process of claim 57 further comprising modifying said boron nitride byproduct.

62. The process of claim 61 wherein said modifying comprises at least one selected from the neutralizing and diluting.

63. The process of claim 57 further comprising a second washing prior to said drying.
